(19) United States
(12) Patent Application Publication
(10) Pub. No.: US 2026/0079532 A1
(43) Pub. Date: Mar. 19, 2026

(54) Electronic Devices with Multi-Layer Cover Layers

(71) Applicant: Apple Inc., Cupertino, CA (US)

(72) Inventor: Christopher D. Jones, Los Gatos, CA (US)

(21) Appl. No.: 19/232,665

(22) Filed: Jun. 9, 2025

Related U.S. Application Data
(60) Provisional application No. 63/695,744, filed on Sep. 17, 2024.

(51) Int. Cl. G06F 1/16; B32B 7/022; B32B 17/10

(52) U.S. Cl. CPC G06F 1/1652; B32B 7/022; B32B 17/10064; B32B 17/10155; B32B 2307/412; B32B 2315/08; B32B 2457/206

(57) ABSTRACT

A foldable electronic device may bend about a bend axis. The device may include a flexible display panel and a display cover layer overlapping the flexible display panel. The flexible display panel and the display cover layer may bend along the bend axis as the device is folded. The display cover layer may be formed from first and second glass layers. The first glass layer may have first and second planar portions joined by a third portion that bends about the bend axis. The second glass layer may have third and fourth portions that respectively overlap the first and second planar portions and that are separated by a gap overlapping the bend axis. The second glass layer may have a higher modulus of elasticity, lower compressive stress, and/or a greater thickness than the first glass layer to provide additional display protection.

This application claims the benefit of U.S. provisional Ser. No. 63/695,744 , filed Sep. 17, 2024, which is hereby incorporated by reference herein in its entirety.

### FIELD

This relates generally to electronic devices, and, more particularly, to electronic devices with displays.

### BACKGROUND

Electronic devices often have displays. Portability may be a concern for some devices, which tends to limit available real estate for displays.

### SUMMARY

An electronic device may be provided with a foldable housing that allows the device to fold and unfold about a bend axis. A flexible display may be mounted in the foldable housing. The flexible display may have an array of pixels forming a display panel. The display panel may be configured to bend along the bend axis as the device is folded.

The display panel may display images that are viewable through a transparent display cover layer that overlaps the display panel. The display cover layer may be formed from first and second glass layers. The first glass layer may have first and second planar portions joined by a third portion that bends about the bend axis. The second glass layer may have third and fourth portions that respectively overlap the first and second planar portions and that are separated by a gap overlapping the bend axis. The second glass layer may have a higher modulus of elasticity, lower compressive stress, and/or a greater thickness than the first glass layer to provide additional display protection.

### BRIEF DESCRIPTION OF THE DRAWINGS

FIG. 1 is a schematic diagram of an illustrative electronic device in accordance with some embodiments.

FIG. 2 is a perspective view of an illustrative electronic device with a display in accordance with some embodiments.

FIG. 3 is a side view of an illustrative electronic device in accordance with some embodiments.

FIG. 4 is a side view of an illustrative cover layer having a hinge region with a thickness that is less than the thickness of other portions of the cover layer in accordance with some embodiments.

FIG. 5 is a side view of an illustrative display having a cover layer with a first layer that extends across a hinge axis and a second layer that has a gap aligned with the hinge axis in accordance with some embodiments.

FIG. 6 is a side view of an illustrative cover layer having a first type of glass that extends across a hinge axis and a second type of glass that has a gap aligned with the hinge axis and that has regions of variable thickness in accordance with some embodiments.

FIG. 7 is a side view of an illustrative cover layer having a first layer that extends across a hinge axis and a second layer that has a gap aligned with the hinge axis and that has a different thickness than the first layer in accordance with some embodiments.

FIG. 8 is a side view of an illustrative cover layer having a first layer of a first type of glass that extends across a hinge axis and a second layer of the first type of glass that has a gap aligned with the hinge axis and that has regions of variable thickness in accordance with some embodiments.

### DETAILED DESCRIPTION

Electronic devices may be provided with displays. Displays may be used for displaying images for users. Displays may be formed from arrays of light-emitting diode pixels or other pixels. For example, a device may have an organic light-emitting diode display or a display formed from an array of micro-light-emitting diodes (e.g., diodes formed from crystalline semiconductor dies).

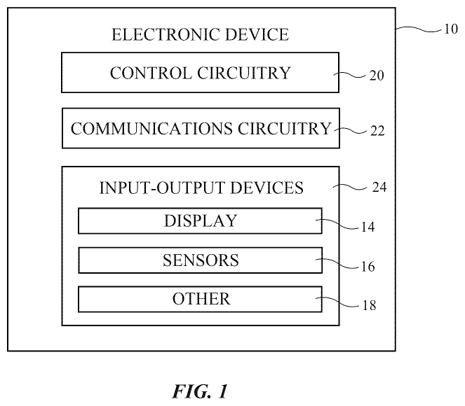

A schematic diagram of an illustrative electronic device having a display is shown in FIG. 1. Device 10 may be a cellular telephone, tablet computer, laptop computer, wristwatch device or other wearable device, a television, a stand-alone computer display or other monitor, a computer display with an embedded computer (e.g., a desktop computer), a system embedded in a vehicle, kiosk, or other embedded electronic device, a media player, or other electronic equipment. Configurations in which device 10 is a cellular telephone, tablet computer, or other portable electronic device may sometimes be described herein as an example. This is illustrative. Device 10 may, in general, be any suitable electronic device with a display.

Device 10 may include control circuitry 20. Control circuitry 20 may include storage and processing circuitry for supporting the operation of device 10. The storage and processing circuitry may include storage such as nonvolatile memory (e.g., flash memory or other electrically-programmable-read-only memory configured to form a solid state drive), volatile memory (e.g., static or dynamic random-access-memory), etc. Processing circuitry in control circuitry 20 may be used to gather input from sensors and other input devices and may be used to control output devices. The processing circuitry may be based on one or more microprocessors, microcontrollers, digital signal processors, baseband processors and other wireless communications circuits, power management units, audio chips, application specific integrated circuits, etc. During operation, control circuitry 20 may use a display and other output devices in providing a user with visual output and other output.

To support communications between device 10 and external equipment, control circuitry 20 may communicate using communications circuitry 22. Circuitry 22 may include antennas, radio-frequency transceiver circuitry (wireless transceiver circuitry), and other wireless communications circuitry and/or wired communications circuitry. Circuitry 22, which may sometimes be referred to as control circuitry and/or control and communications circuitry, may support bidirectional wireless communications between device 10 and external equipment over a wireless link (e.g., circuitry 22 may include radio-frequency transceiver circuitry such as wireless local area network transceiver circuitry configured to support communications over a wireless local area network link, near-field communications transceiver circuitry configured to support communications over a near-field communications link, cellular telephone transceiver circuitry configured to support communications over a cellular telephone link, or transceiver circuitry configured to support communications over any other suitable wired or wireless communications link). Wireless communications may, for example, be supported over a Bluetooth® link, a WiFi® link, a wireless link operating at a frequency between 6 GHz and 300 GHz, a 60 GHz link, or other millimeter wave link, cellular telephone link, wireless local area network link, personal area network communications link, or other wireless communications link. Device 10 may, if desired, include power circuits for transmitting and/or receiving wired and/or wireless power and may include batteries or other energy storage devices. For example, device 10 may include a coil and rectifier to receive wireless power that is provided to circuitry in device 10.

Device 10 may include input-output devices such as devices 24. Input-output devices 24 may be used in gathering user input, in gathering information on the environment surrounding the user, and/or in providing a user with output. Devices 24 may include one or more displays such as display 14. Display 14 may be an organic light-emitting diode display, a liquid crystal display, an electrophoretic display, an electrowetting display, a plasma display, a microelectromechanical systems display, a display having a pixel array formed from crystalline semiconductor light-emitting diode dies (sometimes referred to as microLEDs), and/or other display. Configurations in which display 14 is an organic light-emitting diode display or microLED display are sometimes described herein as an example.

Display 14 may have an array of pixels configured to display images for a user. The pixels may be formed as part of a display panel that is bendable. This allows device 10 to be folded and unfolded about a bend axis. For example, a flexible (bendable) display in device 10 may be folded so that device 10 may be placed in a compact shape for storage and may be unfolded when it is desired to view images on the display.

Sensors 16 in input-output devices 24 may include force sensors (e.g., strain gauges, capacitive force sensors, resistive force sensors, etc.), audio sensors such as microphones, touch and/or proximity sensors such as capacitive sensors (e.g., a two-dimensional capacitive touch sensor integrated into display 14, a two-dimensional capacitive touch sensor overlapping display 14, and/or a touch sensor that forms a button, trackpad, or other input device not associated with a display), and other sensors. If desired, sensors 16 may include optical sensors such as optical sensors that emit and detect light, ultrasonic sensors, optical touch sensors, optical proximity sensors, and/or other touch sensors and/or proximity sensors, monochromatic and color ambient light sensors, image sensors, fingerprint sensors, temperature sensors, sensors for measuring three-dimensional non-contact gestures (“air gestures”), pressure sensors, sensors for detecting position, orientation, and/or motion (e.g., accelerometers, magnetic sensors such as compass sensors, gyroscopes, and/or inertial measurement units that contain some or all of these sensors), health sensors, radio-frequency sensors, depth sensors (e.g., structured light sensors and/or depth sensors based on stereo imaging devices that capture three-dimensional images), optical sensors such as self-mixing sensors and light detection and ranging (lidar) sensors that gather time-of-flight measurements, humidity sensors, moisture sensors, gaze tracking sensors, and/or other sensors. In some arrangements, device 10 may use sensors 16 and/or other input-output devices to gather user input. For example, buttons may be used to gather button press input, touch sensors overlapping displays can be used for gathering user touch screen input, touch pads may be used in gathering touch input, microphones may be used for gathering audio input, accelerometers may be used in monitoring when a finger contacts an input surface and may therefore be used to gather finger press input, etc.

If desired, electronic device 10 may include additional components (see, e.g., other devices 18 in input-output devices 24). The additional components may include haptic output devices, audio output devices such as speakers, light-emitting diodes for status indicators, light sources such as light-emitting diodes that illuminate portions of a housing and/or display structure, other optical output devices, and/or other circuitry for gathering input and/or providing output. Device 10 may also include a battery or other energy storage device, connector ports for supporting wired communication with ancillary equipment and for receiving wired power, and other circuitry.

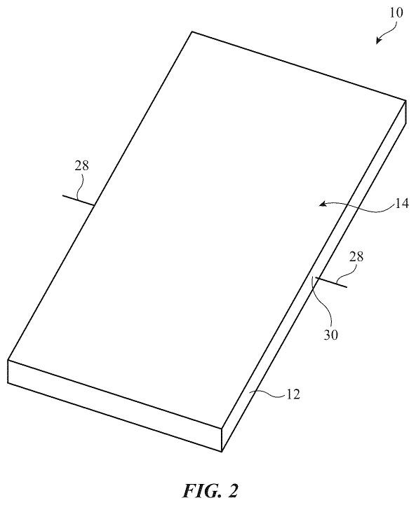

FIG. 2 is a perspective view of electronic device 10 in an illustrative configuration in which device 10 is a portable electronic device such as a cellular telephone or tablet computer. As shown in FIG. 2, device 10 may have a display such as display 14. Display 14 may cover some or all of the front face of device 10. Touch sensor circuitry such as two-dimensional capacitive touch sensor circuitry may be incorporated into display 14.

Display 14 may be mounted in housing 12. Housing 12 may form front and rear housing walls, sidewall structures, and/or internal supporting structures (e.g., a frame, an optional midplate member, etc.) for device 10. Glass structures, transparent polymer structures, and/or other transparent structures that cover display 14 and other portions of device 10 may provide structural support for device 10 and may sometimes be referred to as housing structures. For example, a transparent housing portion such as a glass or polymer housing structure that covers and protects a pixel array in display 14 may serve as a display cover layer for the pixel array while also serving as a housing wall on the front face of device 10. In configurations in which a display cover layer is formed from glass, the display cover layer may sometimes be referred to as a display cover glass or display cover glass layer. The portions of housing 12 on the sidewalls and rear wall of device 10 may be formed from glass or other transparent structures and/or opaque structures. Sidewalls and rear wall structures may be formed as extensions to the front portion of housing 12 (e.g., as integral portions of the display cover layer) and/or may include separate housing wall structures.

Housing 12 may have flexible structures (e.g., bendable housing wall structures) and/or hinge structures such as hinge 30. Hinge 30 may have a hinge axis aligned with device bend axis 28. Hinge 30 and/or flexible housing structures that overlap bend axis 28 may allow housing 12 to bend about bend axis 28. For example, housing 12 may have a first portion on one side of bend axis 28 and a second portion on an opposing side of bend axis 28 and these two housing portions may be coupled by hinge 30 for rotational motion about axis 28.

As housing 12 is bent about bend axis 28, the flexibility of display 14 allows display 14 to bend about axis 28. In an illustrative configuration, housing 12 and display 14 may bend by 180^{o}. This allows display 14 to be folded back on itself (with first and second outwardly-facing portions of display 14 facing each other). The ability to place device 10 in a folded configuration in this way may help make device 10 compact so that device 10 can be stored efficiently. When it is desired to view images on display 14, device 10 may be unfolded about axis 28 to place device 10 in the unfolded configuration of FIG. 2. This allows display 14 to lie flat and allows a user to view flat images on display 14. The ability to fold display 14 onto itself allows device 10 to exhibit an inwardly folding behavior. Display 14 may be sufficiently flexible to allow device 10 to be folded outwardly and/or inwardly.

Device 10 of FIG. 2 has a rectangular outline (rectangular periphery) with four corners. As shown in FIG. 2, a first pair of parallel edges (e.g., the left and right edges of device 10 in the example of FIG. 2) may be longer than a second pair of parallel edges (e.g., the upper and lower edges of device 10 of FIG. 2) that are oriented at right angles to the first pair of parallel edges. In this type of configuration, housing 12 is elongated along a longitudinal axis that is perpendicular to bend axis 28. Housing 12 may have other shapes, if desired (e.g., shapes in which housing 12 has a longitudinal axis that extends parallel to bend axis 28). With an arrangement of the type shown in FIG. 2, the length of device 10 along its longitudinal axis may be reduced by folding device 10 about axis 28.

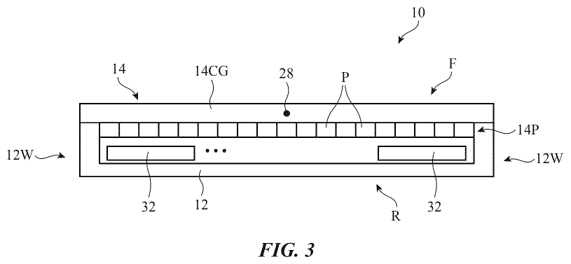

FIG. 3 is a cross-sectional side view of an illustrative foldable electronic device. Device 10 of FIG. 3 may bend about bend axis 28. Bend axis 28 may be aligned with display cover layer 14CG or other structures in device 10. For example, bend axis 28 may pass through a portion of display cover layer 14CG or may be located above or below layer 14CG.

As shown in FIG. 3, display 14 includes an array of pixels P forming display panel 14P under an inwardly facing surface of display cover layer 14CG. Display panel 14P may be, for example, a flexible organic light-emitting diode display or a microLED display in which light-emitting pixels are formed on a flexible substrate layer (e.g., a flexible layer of polyimide or a sheet of other flexible polymer). Flexible support layer(s) for display 14 may also be formed from flexible glass, flexible metal, and/or other flexible structures.

Display cover layer 14CG may be formed from polymer, glass, crystalline materials such as sapphire, other materials, and/or combinations of these materials. To enhance flexibility, a portion of layer 14CG that overlaps bend axis 28 may be locally thinned (e.g., this portion may be thinned relative to portions of layer 14CG that do not overlap bend axis 28). The thickness of layer 14CG (e.g., the non-thinned portions of layer 14CG) may be 50-200 microns, 70-150 microns, 100-200 microns, 100-600 microns, at least 100 microns, at least 200 microns, less than 600 microns, less than 400 microns, less than 250 microns, less than 150 microns, less than 100 microns, at least 50 microns, or other suitable thickness.

In the example of FIG. 3, housing 12 has a portion on rear face R that forms a rear housing wall and has side portions forming sidewalls 12W. The rear housing wall of housing 12 may form a support layer for components in device 10. Housing 12 may also have one or more interior supporting layers (e.g., frame structures such as an optional midplate, etc.). These interior supporting layers and the rear housing wall may have first and second portions that are coupled to opposing sides of a hinge that is aligned with bend axis 28 (see, e.g., hinge 30 of FIG. 2) or may be sufficiently flexible to bend around bend axis 28.

Electrical components 32 may be mounted in the interior of device 10 (e.g., between display 14 and the rear of housing 12. Components 32 may include circuitry of the type shown in FIG. 1 (e.g., control circuitry 20, communications circuitry 22, input-output devices 24, batteries, etc.). Display 14 may be mounted on front face F of device 10. When device 10 is folded about axis 28, display cover layer 14CG, display panel 14P, and the other structures of device 10 that overlap bend axis 28 may flex and bend to accommodate folding.

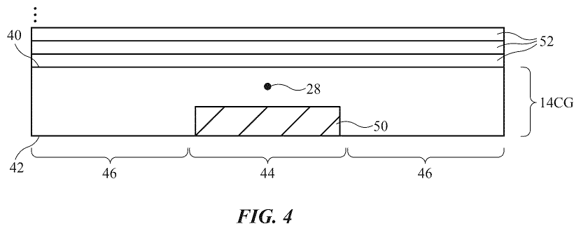

If desired, the outer and/or inner surfaces of display cover layer 14GC may be provided with coatings. These coatings may include, for example, antireflection coatings, anti-scratch coatings, anti-smudge coatings, and/or other coating layers. Consider, as an example, the cross-sectional side view of display cover layer 14CG of FIG. 4. As shown in FIG. 4, display cover layer may have an outer surface (outwardly facing surface) such as surface 40 and an opposing inner surface (inwardly facing surface) such as surface 42. A strip-shaped region of display cover layer 14CG that overlaps and runs parallel to bend axis 28 may have a locally reduced thickness (e.g., a groove or other recess that runs parallel to bend axis 28 may be formed in layer 14CG to form locally reduced thickness portion 44 of layer 14CG). Locally reduced thickness portion 44 of layer 14CG may be thinner than other portions of layer 14CG such as portions 46 (which may be, for example, planar glass layer portions of layer 14CG). The presence of reduced thickness portion 44 in display cover layer 14CG may facilitate bending of display cover layer 14CG about bend axis 28.

To help planarize inner surface 42 and thereby facilitate mounting of display panel 14P against inner surface 42 (e.g., with a layer of adhesive), the elongated recess (groove) in the inner surface of layer 14CG that forms thinned portion 44 may be filled with a polymer such as polymer 50. Polymer 50 may be sufficiently flexible to bend about bend axis 28 when device 10 is opened and closed. The refractive index of polymer 50 may be matched to that of display cover layer 14CG to help minimize light reflections (e.g., by incorporating inorganic nanoparticles in polymer 50). For example, at a wavelength of 500 nm, the refractive index of polymer 50 may differ from that of layer 14CG by less than 0.15, less than 0.1, or less than 0.05 (as examples).

Coating layers 52 may optionally be formed on outer surface 40. Coating layers 52 may include, for example, anti-scratch layers (sometimes referred to as hard coats), protective polymer layers, anti-smudge layers, anti-fog layers, antireflection layers, anti-static layers, adhesion layers, and/or other coatings. In some configurations, each of these functions may be implemented using a separate respective coating layer. In other configurations, a single layer may serve multiple functions. In general, coatings such as coatings 52 may be formed on outer surface 40 and/or inner surface 42. In the illustrative configuration of FIG. 4, coatings 52 are formed on outer surface 40.

Coatings 52 may be provided in any suitable order. As one example, the lowermost coating of coatings 52 (e.g., a coating layer formed directly on surface 40 of FIG. 4) may be a hard coat or other anti-scratch layer that helps prevent scratches that could damage layer 14CG. An antireflection coating may be formed on top of the anti-scratch layer. The antireflection layer may be a thin-film interference filter antireflection coating containing a stack of thin-film layers such as dielectric sublayers of alternating refractive index. One of the thin-film layers may be a conductive layer such as a transparent semiconductor layer (e.g., an indium tin oxide layer) that serves as an antistatic layer. An anti-smudge coating or anti-fog coating may be formed on top of the antireflection layer. Anti-smudge coatings (e.g., hydrophobic polymer coatings) may help reduce fingerprints and other undesired marks on the surfaces of display 14. An example of an anti-smudge coating is a fluoropolymer coating (e.g., a fluoropolymer formed from evaporated perfluoropolyether) that serves as an oleophobic layer. Fluoropolymers can be adhered to underlying coating layers using an intervening adhesion layer.

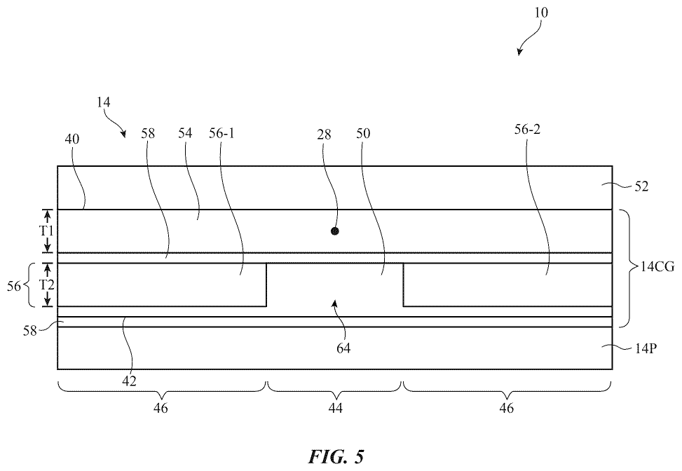

In some configurations, cover layer 14CG may be a single, monolithic piece of glass that includes a locally reduced thickness portion 44 that is thinned relative to portions 46 of cover layer 14CG (e.g., non-bending portions of cover layer 14CG that do not overlap hinge axis 28 and that do not need to bend). In other configurations, cover layer 14CG may be formed from multiple layers of transparent material such as glass, plastic, sapphire, or other suitable transparent material. This type of arrangement is illustrated in FIG. 5.

As shown in FIG. 5, display 14 of device 10 may include cover layer 14CG interposed between display panel 14P and one or more coatings 52. Cover layer 14CG may include one or more overlapping transparent layers such as first transparent layer 54 and second transparent layer 56. First transparent layer 54 (sometimes referred to as outer transparent layer 54 or outer glass layer 54) and second transparent layer 56 (sometimes referred to as inner transparent layer 56 or inner glass layer 56) may be formed from glass, plastic, sapphire, or any other suitable transparent material. A first adhesive layer 58 may be used to attach inner layer 56 to outer layer 54, and a second adhesive layer 58 may be used to attach inner layer 56 to display panel 14P.

Outer layer 54 may extend across fold axis 28 and may have uniform thickness T1 across regions 46 and 44. For example, thickness T1 of outer layer 54 may be less than 100 microns, less than 200 microns, less than 400 microns, or greater than 400 microns. Thickness T1 of outer layer 54 may be sufficiently small to permit outer layer 54 to bend in region 44 overlapping hinge axis 28.

Inner layer 56 may include first and second portions 56-1 and 56-2 in regions 46 separated by gap 64 in region 44. Gap 64 may be a recess that extends partway through layer 56 or may be a through-hole that extends entirely through layer 56. Gap 64 may overlap hinge axis 28, thereby allowing first portion 56-1 to rotate relative to second portion 56-2 of layer 56 as display 14 is folded and unfolded. First and second portions 56-1 and 56-2 of layer 56 may have uniform thickness T2. Thickness T2 may be equal to or different than thickness T1 of layer 54. For example, thickness T2 may be less than 100 microns, less than 200 microns, less than 400 microns, or greater than 400 microns. Since layer 56 includes gap 64 overlapping hinge axis 28 and does not need to bend, layer 56 may have a greater thickness than layer 54, if desired.

To help planarize inner surface 42 and thereby facilitate mounting of display panel 14P against inner surface 42 (e.g., with a layer of adhesive), the elongated recess (groove) in the inner surface of layer 14CG that forms thinned portion 44 may be filled with a polymer such as polymer 50. Polymer 50 may be sufficiently flexible to bend about bend axis 28 when device 10 is opened and closed. The refractive index of polymer 50 may be matched to that of display cover layer 14CG to help minimize light reflections (e.g., by incorporating inorganic nanoparticles in polymer 50). For example, at a wavelength of 500 nm, the refractive index of polymer 50 may differ from that of inner layer 56 by less than 0.15, less than 0.1, or less than 0.05 (as examples). Polymer 50 may be located only in gap 64 or may also be present as a thin layer between display panel 14P and inner layer 56.

In some arrangements, which are sometimes described herein as an example, outer layer 54 may be a first type of glass and inner layer 56 may be a second type of glass having one or more different properties than outer glass 54. For example, inner layer 56 may have a higher modulus of elasticity than outer layer 54, may exhibit lower compressive stress than outer layer 54, may have a greater thickness than outer layer 54, may have a different refractive index than outer layer 54 (e.g., a refractive index that more closely matches that of polymer 50), and/or may have other properties that differ from those of outer layer 54. The presence of layer 56 in regions 46 may help protect display panel 14P from damage during operation of device 10. For example, if a sharp object or drop event causes damage to outer layer 54, the presence of a stiffer layer such as inner layer 56 behind outer layer 54 may help prevent the damage from reaching display panel 14P. This allows outer layer 54 to be sufficiently thin to achieve the desired bending radius of cover layer 14CG. Additionally, since layers 54 and 56 are separate layers (as opposed to a monolithic piece of glass with variable thickness), outer glass layer 54 may be formed with uniform thickness across regions 46 and 44, which helps prevent variations in the amount of expansion that occurs across portions 46 and 44 of layer 54 during ion exchange.

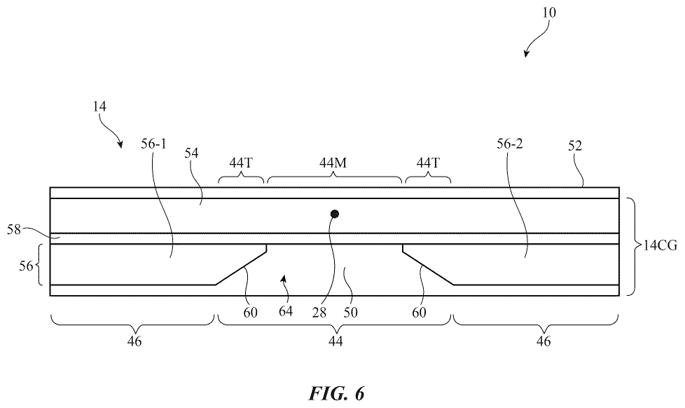

It may be desirable to configure the cross-sectional profile of inner layer 56 of display cover layer 14CG to help avoid distortion of the image on display panel 14P due to changes in the refraction of light from thickness variations and/or gaps such as gap 64. As shown in FIG. 6, for example, inner layer 56 may include tapered edges such as tapered edges 60 on opposing sides of gap 64. Tapered edges 60 of inner glass layer 56 may provide locally reduced thickness region 44 of cover glass 14CG with varying thickness portions 44T. Portions 44T may be tapered and characterized by smoothly and gradually varying thicknesses. Portions 44T may be located at the outer edges of locally reduced thickness region 44 and may provide layer 14CG with a gradual transition between the thinnest part of region 44 (e.g., portion 44M of portion 44 of cover layer 14CG, where outer glass layer 54 overlaps gap 64 and does not overlap any portion of inner glass layer 56) and the thicker portions of layer 14CG such as portions 46 (e.g., where outer glass layer 54 overlaps non-thinned portions of inner glass layer 56). By gradually changing the thickness of inner glass layer 56, undesired visual artifacts and stress concentration features may be avoided.

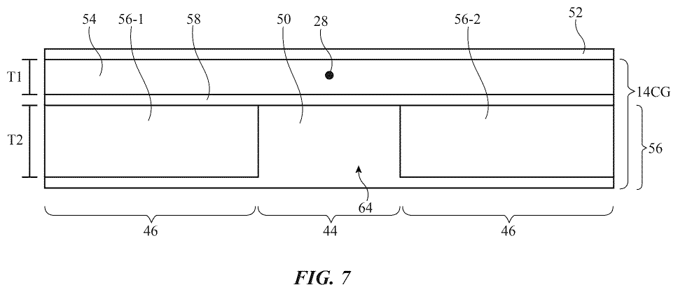

In addition to or instead of forming inner layer 56 with a higher modulus of elasticity than outer layer 54, inner layer 56 may be provided with a greater thickness than outer layer 54 to provide additional display protection without inhibiting bending in region 44 where cover layer 14CG overlaps bend axis 28. This type of arrangement is illustrated in FIG. 7. As shown in FIG. 7, outer layer 54 may have thickness T1 and inner layer 56 may have thickness T2. Thickness T2 may be greater than thickness T1 (e.g., thickness T2 may be 5% greater than thickness T1, 10% greater than thickness T1, 25% greater than thickness T1, 50% greater than thickness T1, more than 50% greater than thickness T1, less than 50% greater than thickness T1, etc.).

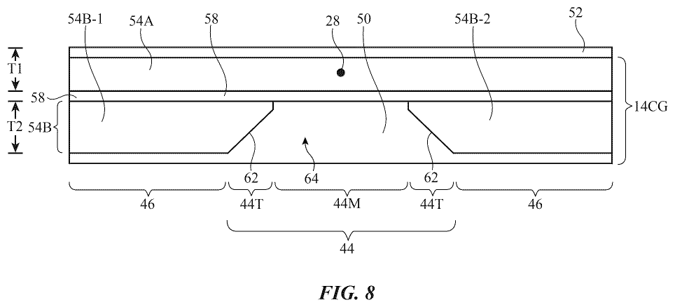

In the example of FIG. 8, display cover layer 14CG includes multiple layers such as first transparent layer 54A and second transparent layer 54B. First transparent layer 54A (sometimes referred to as outer transparent layer 54A or outer glass layer 54A) and second transparent layer 54B (sometimes referred to as inner transparent layer 54B or inner glass layer 54B) may be formed from glass, plastic, sapphire, or any other suitable transparent material. Adhesive layer 58 may be used to attach inner layer 54B to outer layer 54A. An additional adhesive layer may be used to attach inner layer 54B to display panel 14P (FIGS. 3 and 4).

Outer layer 54A may extend across fold axis 28 and have uniform thickness T1 across regions 46 and 44. For example, thickness T1 of outer layer 54A may be less than 100 microns, less than 200 microns, less than 400 microns, or greater than 400 microns. Thickness T1 of outer layer 54A may be sufficiently small to permit outer layer 54A to bend in region 44 overlapping hinge axis 28.

Inner layer 54B may include first and second portions 54B-1 and 54B-2 in regions 46 separated by gap 64 in region 44. Gap 64 may be a recess that extends partway through layer 54B or may be a through-hole that extends entirely through layer 54B. Gap 64 may overlap hinge axis 28, thereby allowing first portion 54B-1 to move relative to second portion 54B-2 of layer 54B as display 14 is folded and unfolded. First and second portions 54B-1 and 54B-2 of layer 54B may have uniform thickness T2, or may have a variable thickness with tapered edges on opposing sides of gap 64. Thickness T2 may be equal to or different than thickness T1 of layer 54A. For example, thickness T2 may be less than 100 microns, less than 200 microns, less than 400 microns, or greater than 400 microns. Since layer 54B includes gap 64 overlapping hinge axis 28 and does not need to bend, layer 54B may have a greater thickness than layer 54A, if desired.

If desired, gap 64 may be filled with a polymer such as polymer 50. Polymer 50 may be sufficiently flexible to bend about bend axis 28 when device 10 is opened and closed. The refractive index of polymer 50 may be matched to that of display cover layer 14CG to help minimize light reflections (e.g., by incorporating inorganic nanoparticles in polymer 50). For example, at a wavelength of 500 nm, the refractive index of polymer 50 may differ from that of inner layer 54B by less than 0.15, less than 0.1, or less than 0.05 (as examples). Polymer 50 may be located only in gap 64 or may also be present as a thin layer between display panel 14P and inner layer 54B.

In the example of FIG. 8, outer layer 54A and inner layer 54B are formed from the same type of glass. For example, outer layer 54A and inner layer 54B may have the same modulus of elasticity, may exhibit the same amount of compressive stress, and/or may have the same refractive index. The presence of layer 54B in regions 46 may help protect display panel 14P from damage during operation of device 10. For example, if a sharp object or drop event causes damage to outer layer 54A, the presence of inner layer 54B may help prevent the puncture from reaching display panel 14P. This allows outer layer 54A to be sufficiently thin to achieve the desired bending radius of cover layer 14CG. Additionally, since layers 54A and 54B are separate layers (as opposed to a monolithic piece of glass with variable thickness), outer glass layer 54A may be formed with uniform thickness across regions 46 and 44, which helps prevent variations in the amount of expansion that occurs across portions 46 and 44 of layer 54A during ion exchange.

As shown in FIG. 8, inner layer 54B may include tapered edges such as tapered edges 62 on opposing sides of gap 64. Tapered edges 62 of inner glass layer 54B may provide locally reduced thickness region 44 of cover glass 14CG with varying thickness portions 44T. Portions 44T may be tapered and characterized by smoothly and gradually varying thicknesses. Portions 44T may be located at the outer edges of locally reduced thickness region 44 and may provide layer 14CG with a gradual transition between the thinnest part of region 44 (e.g., portion 44M of portion 44 of cover layer 14CG, where outer glass layer 54A overlaps gap 64 and does not overlap any portion of inner glass layer 54B) and the thicker portions of layer 14CG such as portions 46 (e.g., where outer glass layer 54A overlaps non-thinned portions of inner glass layer 54B). By gradually changing the thickness of inner glass layer 54B, undesired visual artifacts and stress concentration features may be avoided. This is merely illustrative. If desired, inner glass layer 54B may have uniform thickness and may not include any tapered edges (e.g., similar to layer 56 of FIG. 5).

As described above, one aspect of the present technology is the gathering and use of information such as information from input-output devices. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

The foregoing is merely illustrative and various modifications can be made to the described embodiments. The foregoing embodiments may be implemented individually or in any combination.

What is claimed is:

1. An electronic device, comprising:
a foldable housing that is configured to bend about a bend axis;
a flexible display panel that overlaps the bend axis; and
a display cover layer that overlaps the flexible display panel, wherein the display cover layer comprises:
a first glass layer that extends across the bend axis; and
a second glass layer having a gap aligned with the bend axis.

2. The electronic device defined in claim 1 wherein the second glass layer has a higher modulus of elasticity than the first glass layer.

3. The electronic device defined in claim 1 wherein the second glass layer exhibits lower compressive stress than the first glass layer.

4. The electronic device defined in claim 1 wherein the first glass layer has uniform thickness.

5. The electronic device defined in claim 4 wherein the second glass layer comprises first and second portions with uniform thickness and wherein the gap separates the first portion from the second portion.

6. The electronic device defined in claim 4 wherein the second glass layer comprises first and second portions having respective first and second tapered edges on opposing sides of the gap.

7. The electronic device defined in claim 4 wherein the second glass layer is thicker than the first glass layer.

8. The electronic device defined in claim 1 further comprising an adhesive layer that attaches the second glass layer to the first glass layer.

9. The electronic device defined in claim 8 further comprising an additional adhesive layer that attaches the second glass layer to the flexible display panel.

10. The electronic device defined in claim 1 further comprising a transparent polymer that fills the gap.

11. The electronic device defined in claim 1 wherein the first and second glass layers have the same modulus of elasticity.

12. A display, comprising:
a flexible display having first and second display regions that fold relative to one another about a fold axis; and
a cover layer through which the flexible display displays images, the cover layer comprising:
an outer glass layer comprising first and second portions respectively overlapping the first and second display regions and joined by a third portion that bends about the fold axis, wherein the outer glass layer has uniform thickness across the first, second, and third portions; and
an inner glass layer comprising third and fourth portions respectively overlapping the first and second display regions and separated by a gap that overlaps the fold axis.

13. The display defined in claim 12 further comprising:
a first adhesive layer interposed between the inner and outer glass layers; and
a second adhesive layer interposed between the inner glass layer and the flexible display.

14. The display defined in claim 12 wherein the third and fourth portions each have a tapered edge facing the gap.

15. The display defined in claim 12 wherein the third and fourth portions each have uniform thickness.

16. The display defined in claim 12 wherein the inner glass layer has a higher modulus of elasticity than the outer glass layer.

17. The display defined in claim 12 wherein the inner glass layer exhibits lower compressive stress than the outer glass layer.

18. A foldable display cover layer, comprising:
a first glass layer comprising first and second planar portions joined by a third portion that bends about a fold axis, wherein the first glass layer has uniform thickness across the first, second, and third portions; and
a second glass layer comprising third and fourth portions respectively overlapping the first and second portions of the first glass layer, wherein the third and fourth portions are separated by a gap that overlaps the fold axis, wherein the second glass layer has at least one property that is different from the first glass layer, and wherein the at least one property is selected from the group consisting of: modulus of elasticity, compressive stress, and thickness.

19. The foldable display cover layer defined in claim 18 further comprising a transparent polymer in the gap.

20. The foldable display cover layer defined in claim 18 wherein the third and fourth portions each have a tapered edge facing the gap.
